(19) United States
(12) Patent Application Publication
(10) Pub. No.: US 2003/0010706 A1
(43) Pub. Date: Jan. 16, 2003

(54) Diesel fuel with interchangeable cartridge

(76) Inventors: Paolo Baracchi, Torino (IT); Bruno Beccari, Mantova (IT); Claudio Crovetti, Mantova (IT); Sergio Tallano, Porto Mantovano (IT)

Correspondence Address: Modiano & Associati, Via Meravigli 16, Milano, 20123, IT

(21) Appl. No.: 10/069,275

(22) PCT Filed: Jul. 5, 2001
(86) PCT No.: PCT/EP01/07718

(30) Foreign Application Priority Data
Jul. 17, 2000 (IT) MI2000A001615

(51) Int. Cl. B01D 27/06

(52) U.S. Cl. 210/457; 210/493.2

(57) ABSTRACT

A Diesel fuel filter (1) with interchangeable cartridge, which comprises a filtering mass or cartridge (2) which is contained within a container which has a side wall (3) and a bottom (4) and is provided with a lid (6) which is fixed detachably. The filter further comprises a duct (8) which is located in a peripheral region of the container and is suitable to connect a fuel intake connector (9) to a duct (7) which is formed within the lid (6) and is provided with passages (10) which open onto the portion of space (11) between the filtering mass (2) and the side wall (3) of the container, so as to allow the fuel to access the filtering mass (2), through which it flows from the outside inward. A fuel discharge connector (14) is furthermore provided at the bottom (4) of the container and is open in the central region of the portion of space delimited inside the filtering mass (2).

### BACKGROUND OF THE INVENTION

The present invention relates to a Diesel fuel filter with interchangeable cartridge.

It is known that the filters inserted in the circuit that supplies the fuel of Diesel engines, commonly known as Diesel fuel, comprise, inside a container, a filtering mass, known as cartridge, which is designed to be crossed by the fuel which flows inside the filter between an intake connector and a discharge connector.

Several kinds of filters are available, and in one of them the container is provided with a lid which is fixed detachably so as to allow easy access to the inside of the filter; in this manner, when a cartridge has exhausted its operating capability, it is replaced easily, leaving in place the rest of the filter, with clear advantages in terms of operation, cost and environmental protection.

### SUMMARY OF THE INVENTION

These filters however are not entirely satisfactory; accordingly, the aim of the present invention is to provide a filter with interchangeable cartridge having improved characteristics.

This aim is achieved by a Diesel fuel filter with interchangeable cartridge, according to the invention, which comprises a filtering mass or cartridge which is contained within a container which has a side wall and a bottom and is provided with a lid which is fixed detachably, characterized in that it comprises a duct which is located in the peripheral region of the container and is suitable to connect a fuel intake connector to a duct which is formed within the lid and is provided with passages which open onto the portion of space between the filtering mass and the side wall of the container, so as to allow the fuel to access said filtering mass, through which it flows from the outside inward, a fuel discharge connector being provided at the bottom of the container and being open in the central region of the portion of space delimited inside the filtering mass.

### BRIEF DESCRIPTION OF THE DRAWINGS

Further characteristics and advantages of the present invention will become better apparent from the description of two preferred but not exclusive embodiments thereof, illustrated only by way of non-limitative example in the accompanying drawings, wherein:

FIG. 1 is a sectional view of a first embodiment of the filter according to the invention;

FIG. 2 is a sectional view of a second embodiment of the invention.

### DESCRIPTION OF THE PREFERRED EMBODIMENTS

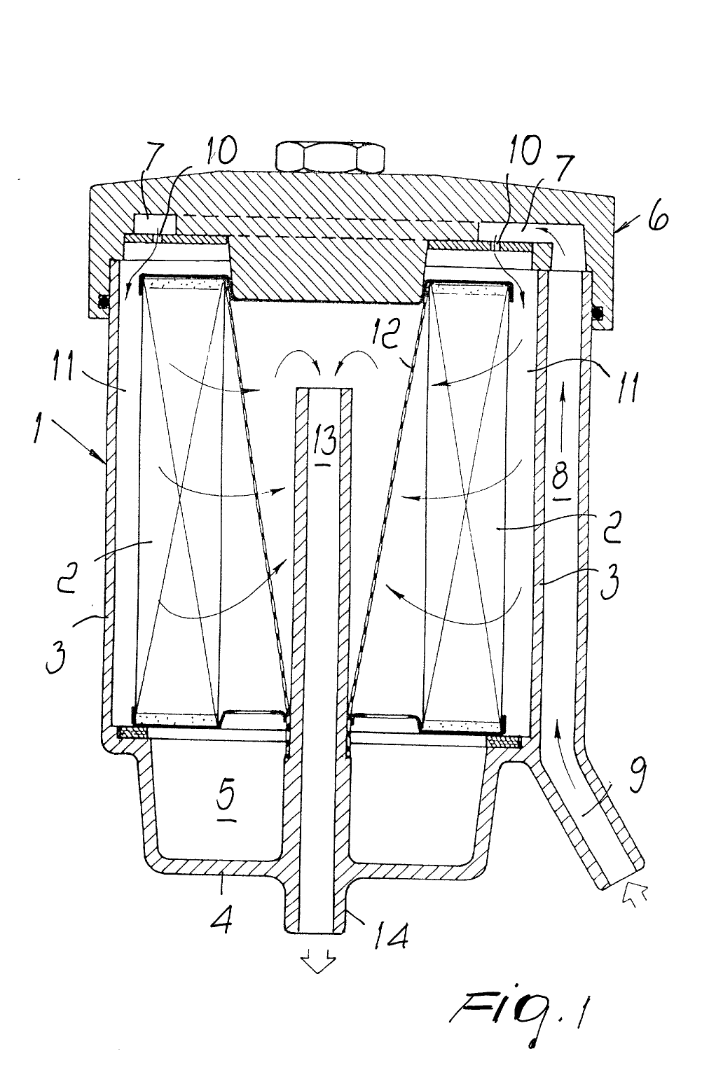

With reference to FIG. 1, the reference numeral 1 generally designates a filter which comprises a filtering mass or cartridge 2 which is contained within a container, which has a side wall 3 and a bottom 4 with a corresponding water collection chamber 5, as described in greater detail hereinafter; a lid, designated by the reference numeral 6, is detachably associated with said container.

One of the main features of the invention is the presence of a duct 7 formed in the lid 6, which is connected by means of a duct 8 located in a peripheral region of the container to a fuel intake connector 9 and is provided with passages such as 10 which open onto a portion of space 11 lying between the filtering mass 2 and the side wall 3 of the container.

This produces a circulation of the fuel inside the filter which is illustrated by the arrows in the figure; the fuel arrives in the duct 7, by means of the duct 8, exits from there through the passages such as 10, crosses the filtering mass 2 from the outside inward, encounters a micromesh 12 which retains water droplets that are present in the fuel, sending them by gravity to the collection chamber 5, and enters a duct 13, which extends inside the filter a fuel discharge connector 14 of the filter.

Attention is drawn to the synergistic relationship that arises between the inverted truncated cone of the micromesh 12 and the extension of the duct 13 so as to reach the wider region of the micromesh 12, with particularly facilitated insertion of the fuel in said duct.

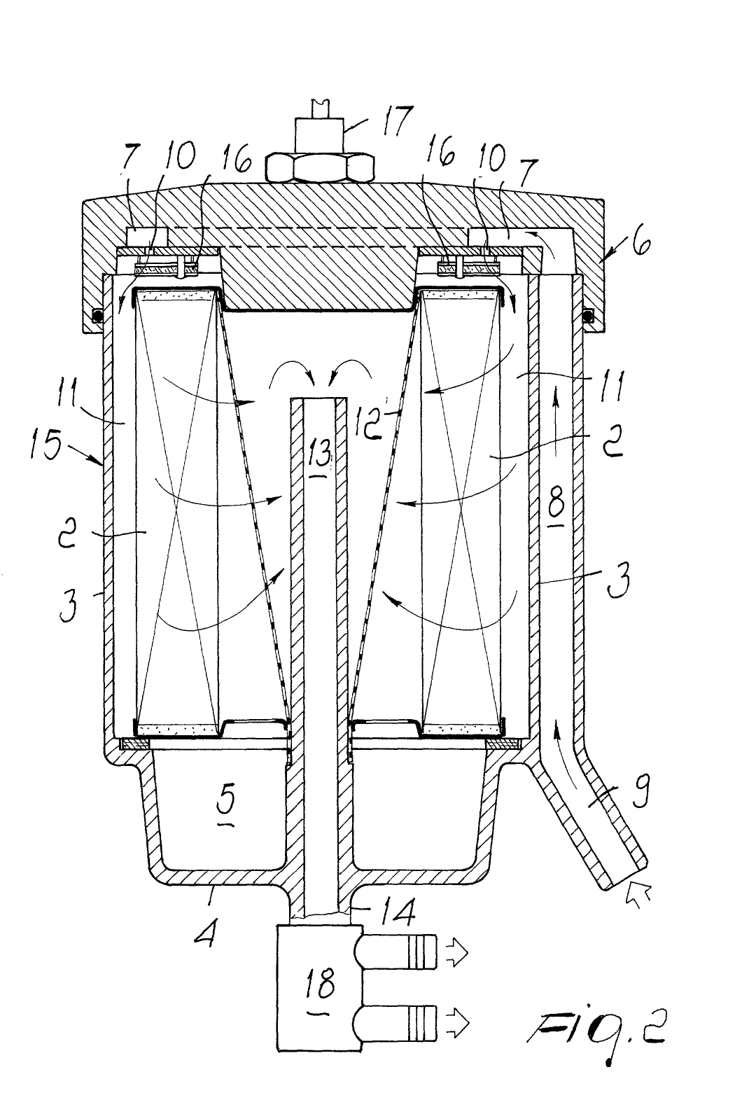

The second embodiment of the invention generally designated by the reference numeral 15, which is shown in FIG. 2, has two additional elements with respect to the first embodiment of FIG. 1, which is otherwise unchanged.

The first element is constituted by a heating element 16 with an electric resistor which is supplied by means of a connector 17, which is annular and is supported by the structure of the lid 6 and is located at the passages such as 10 so that it is struck by the fuel that exits from said passages.

The second element is constituted by a so-called overflow valve 18.

Such valve is per se known and is meant to separate the fuel that exits from the filter into two streams which are directed respectively so as to feed the engine and to a recirculation system in the tank; in the prior art, such valve is located in the ducts that connect the filter to the engine, whereas in the present invention it is associated directly with the filter in various manners.

Such valve can in fact be associated monolithically with the fuel discharge connector, as in the case of FIG. 2, but could be detachably associated with the connector, for example by threading, or could be formed within the bottom 4 of the container.

The disclosed invention is susceptible of numerous modifications and variations, all of which are within the scope of the inventive concept; thus, for example, the duct 7 may be provided in any manner in the lid 6 with the corresponding passages such as 10, and only the heater, or only the overflow valve, might be provided to integrate the embodiment of FIG. 1.

Conveniently the filter is further provided with manually- or automatically-operated means for evacuating the water that has accumulated in the collection chamber 5.

The disclosures in Italian Patent Application No. MI2000A001615 from which this application claims priority are incorporated herein by reference.

1. A Diesel fuel filter (1) with interchangeable cartridge, comprising a filtering mass or cartridge (2) which is contained within a container which has a side wall (3) and a bottom (4) and is provided with a lid (6) which is fixed detachably, characterized in that it comprises a duct (8) which is located in a peripheral region of the container and is suitable to connect a fuel intake connector (9) to a duct (7) which is formed within the lid (6) and is provided with passages (10) which open onto the portion of space (11) between the filtering mass (2) and the side wall (3) of the container, so as to allow the fuel to access said filtering mass, through which it flows from the outside inward, a fuel discharge connector (14) being provided at the bottom (4) of the container and being open in a central region of the portion of space delimited inside the filtering mass (2).

2. The filter according to claim 1, characterized in that the duct (7) formed within the lid (6) is provided with said passages (10) which are uniformly distributed along its entire extension and open onto the portion of space lying between the filtering mass (2) and the side wall (3) of the container.

3. The filter according to claim 2, characterized by the presence of a heating element (16) of the electric resistor type, which is supported by the structure of the lid (6) and is located at the passages (10) of the duct (7) formed in said lid (6), so as to be struck by the fuel that exits from said passages.

4. The filter according to claim 1, characterized by the presence of an overflow valve (18) at the fuel discharge connector (14).

5. The filter according to claim 4, characterized in that said overflow valve (18) is formed within the bottom (4) of the container.

6. The filter according to claim 5, characterized in that the overflow valve (18) is monolithically associated with the bottom (4) of the container.

7. The filter according to claim 5, characterized in that the overflow valve (18) is detachably associated with the bottom (4) of the container.

8. The filter according to claim 1, characterized by the presence of a micromesh (12) which is suitable to capture water droplets that are present in the stream of fuel that exits from the filtering mass (2) in order to send them to a collection chamber (5) provided at the bottom (4) of the container, said collection (5) chamber being shaped like a truncated cone which is open toward the lid of the filter, the fuel discharge connector (14) extending inside said filter into a duct which runs along the longitudinal axis of the container and arrives proximate to the lid (6).
